(19) United States
(12) Patent Application Publication
(10) Pub. No.: US 2007/0227677 A1
(43) Pub. Date: Oct. 4, 2007

(54) Cordless window covering

(76) Inventors: Fu-Lai Yu, San Hsia Town (TW); Chin-Tien Huang, San Hsia Town (TW)

Correspondence Address: OLSON & HIERL, LTD., 20 NORTH WACKER DRIVE, 36TH FLOOR, CHICAGO, IL, 60606, US

(21) Appl. No.: 11/392,340

(22) Filed: Mar. 29, 2006

(51) Int. Cl. E06B 9/30

(52) U.S. Cl. 160/170

(57) ABSTRACT

A cordless window covering having a differential suspension mechanism. The suspension mechanism is composed of a first rotary drum for winding and unwinding the suspension cord of a window covering and a second rotary drum housing a spring with one end connected to the second rotary drum and the other end of the spring connected to an axle. Rotation of the first rotary drum and at least one end of the spring are linked by a transmission system. In operation, the transmission system creates a differential rotation rate between the first rotary drum and the relative rotation rate of the two ends of the spring. In this manner, a greater length of cord can be deployed for with a shorter length of spring extension.

### FIELD OF INVENTION

This invention relates to window coverings. In particular, this invention relates to cordless window coverings where a user does not need to manipulate a control cord to raise or lower the window covering.

### BACKGROUND OF INVENTION

Window coverings are well known in the art. A window covering typically contains a number of light blocking sections that extend horizontally across the width of a window space or other architectural opening. These light blocking sections can take a myriad of forms such as that of cellular shades, slats in a Venetian blind, and the flat sheet of a Roman shade. In these conventional window coverings, at least one suspension cord hangs down through the light blocking sections from the head rail to a ballast portion, such as a bottom rail. The window covering is raised and lowered by a user manually raising or lowering the suspension cord. After the covering is drawn to the desired height, a brake mechanism or cord lock engages the suspension cord to hold the suspension cord and correspondingly the window covering in place at the desired height.

As an alternative to conventional control cords, cordless window coverings have been developed. A cordless window covering operates differently than a conventional window covering in that the window covering is raised and lowered by direct manipulation of the window covering itself rather than through manipulation of a suspension cord by the user. Like a conventional window covering, the cordless window covering employs suspension cords extending from the head rail through the light blocking elements and connected to the ballast portion or bottom rail. A constant force is applied to bias the suspension cord towards the head rail. This force counters the downward gravitational force caused by the weight of the ballast portion and light blocking elements, which is constant, such that the portion of the window covering is maintained at equilibrium. The constant upward force biasing the suspension cord toward the head rail is typically maintained by use of a coiled spring such as a spiral spring or a constant force spring.

The smooth raising and lowering function of a cordless window covering relies heavily on continually balancing the weight of the window covering with an upwards force exerted by the spring on the suspension cords. When the upward force exerted by the spring does not balance the downward gravitational weight of the window covering, the window covering will not remain in the desired position. When the ballast portion of the window covering is lifted upwards or pulled downwards by a user, the spring ideally exerts sufficient force to instantaneously balance the weight of the window covering in order for the window covering to remain at the adjusted position.

When a constant force spring is used, the force exerted by the spring to resist uncoiling is constant since the change in the radius of curvature is constant. When other resilient means or non-constant force springs are used, a cord lock or brake that engages the suspension cord may be used to provide a frictional force to resist excessive upward or downward forces.

One disadvantage of the conventional cordless window covering is that the length of the coiled spring limits the range of expansion of the window covering. Since the weight of the window covering is constant, maintaining a constant force requires the spring to be within its linear response range throughout the entire range of motion for the window covering. In ranges where the spring response is nonlinear, no equilibrium between the spring force and the weight of the window covering can be reached.

What is needed is an improved cordless window covering and suspension mechanism that reduces the range of extension required on a coiled spring while permitting a window covering to operate in the full desired range of motion. The present invention meets these desires and overcomes the shortcomings of the prior art.

### SUMMARY OF THE INVENTION

The present invention is a cordless window covering with a differentially geared suspension mechanism adapted to translate a linear length of cord wound to a reduced amount of extension of a spring. In other words, by translating the length of the suspension cord of the window covering into a lesser linear distance of coil extension, the entire range of motion of a window covering may be accommodated without exceeding the range of extension of the coil corresponding to its linear response range, i.e., equilibrium force. Additionally, a larger range of window covering extension can be accommodated by a given size spring. A preferred embodiment of the window covering also includes a ballast element, such as a bottom rail, and at least one light blocking element. At least one suspension cord is associated with the ballast element and a suspension mechanism.

The suspension mechanism, preferably mounted in a head rail, is composed of a first rotary drum adapted to wind and unwind the suspension cord and a second rotary drum housing a spring. The spring is mounted at one end to an axle and is mounted at the second end to the second rotary drum. A transmission system operatively connects the first rotary drum and at least of the axle or the second rotary drum. The transmission system can be composed of a system of gears, belts, or other drive means.

With the inner end of the spring mounted to the axle and the outer end of the spring mounted to the second rotary drum, extension and contraction of the spring can occur in three ways. First, the inner end of the spring may be fixed from rotation while the outer end of the spring attached to the drum rotates. Secondly, the end attached to the drum may be fixed from rotation while the inner end of spring is extended and contracted by rotation of the axle. Finally, both the axle and the drum rotate, but at different rates. This causes the inner end and the outer end of the spring rotate at different rates, causing extension and contraction of the spring by virtue of their relative movement.

In operation, the transmission system creates a differential in the rotational displacement between the first rotary drum and the relative rotational displacement between the two ends of the spring. With similarly sized drums, the first rotary drum rotates at a greater rotational rate than the relative rotational movement of the two ends of the spring. In other words, the first rotary drum rotates faster than the spring uncoils. This results in a greater length of cord that can be deployed for a given revolution of the spring. This reduction in the spring's necessary range of extension enables the spring to remain within its linear response range throughout the movement range of the suspension cord. Accordingly, undesired variations in the force provided by the spring to balance and resist the weight of window covering are minimized.

### BRIEF DESCRIPTION OF THE DRAWINGS

In the drawings,

FIG. 1 is a front view of a preferred embodiment of the cordless window covering in accordance with the present invention;

FIG. 2A is a perspective view of the cordless window covering of FIG. 1 in the extended position;

FIG. 2B is a perspective view of the cordless window covering of FIG. 1 in the retracted position;

FIG. 3 is a side view of the suspension mechanism of the cordless window of FIG. 1;

FIG. 4 is a schematic top view of the suspension mechanism of FIG. 3;

FIG. 5 is an exploded view of the suspension mechanism of FIG. 3;

FIG. 6 is a cutaway view of the winding gear assembly in the suspension mechanism;

FIG. 6A is an exploded view of the winding gear assembly of FIG. 6;

FIG. 6B is a cutaway exploded view of the winding gear assembly of FIG. 6;

FIG. 7 is an exploded view of the loading gear assembly in the suspension mechanism;

FIG. 8 is a perspective view of the suspension mechanism of FIG. 3;

FIG. 9 is a perspective view of a suspension mechanism of an alternate embodiment;

FIG. 10 is an exploded view of the suspension mechanism of FIG. 9;

FIG. 11 is a perspective view of a suspension mechanism of another alternate embodiment; and

FIG. 12 is an exploded view of the suspension mechanism of FIG. 11.

### DESCRIPTION OF THE PREFERRED EMBODIMENTS OF THE PRESENT INVENTION

The invention disclosed herein is susceptible to embodiment in many different forms. The embodiments shown in the drawings and described in detail below is only for illustrative purposes. The disclosure is intended as an exemplification of the principles and features of the invention, but does not limit the invention to the illustrated embodiments.

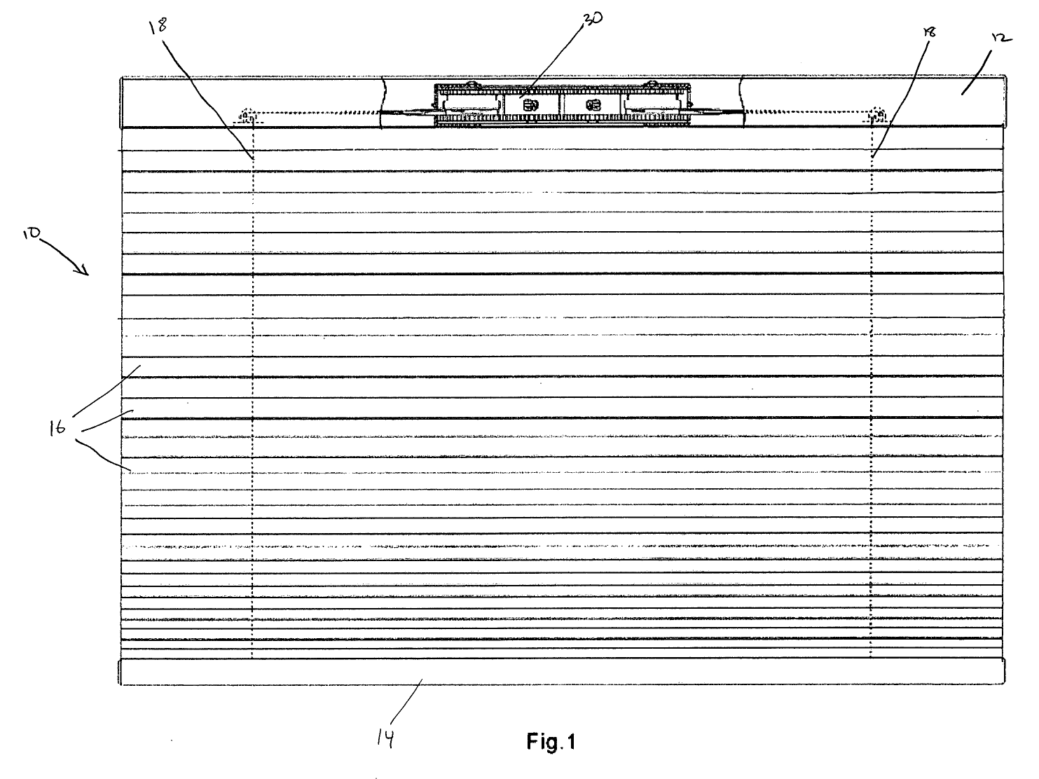

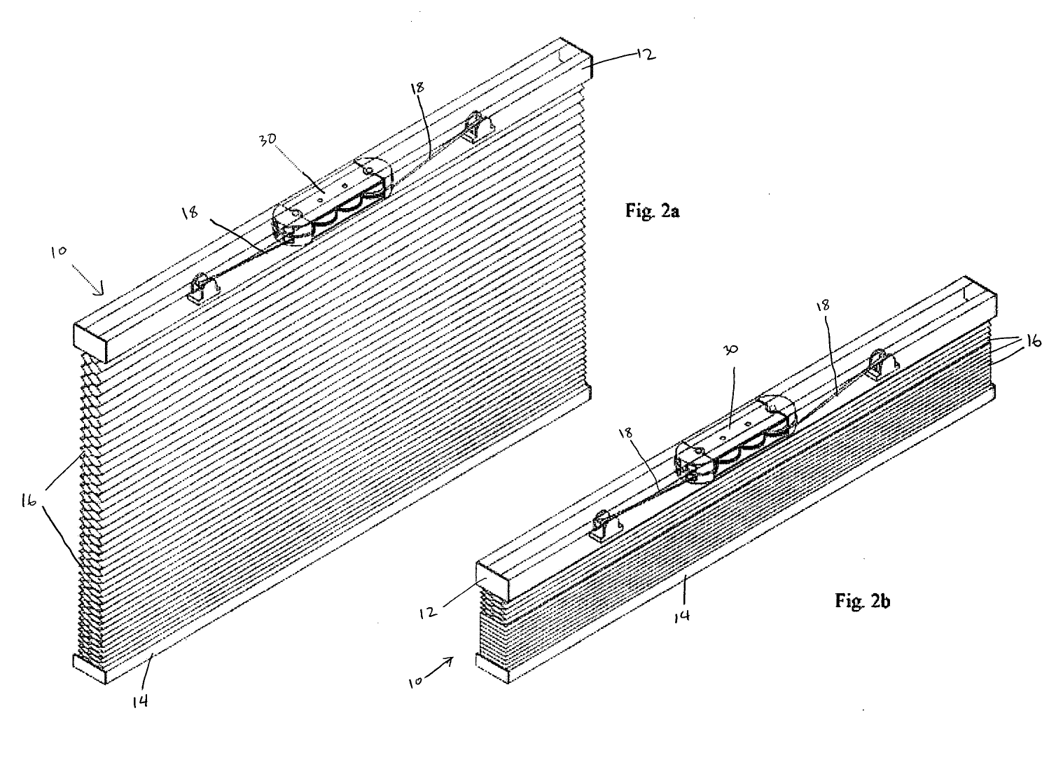

Referring to FIGS. 1, 2A and 2B, a preferred embodiment of the cordless window covering 10 according to the present invention is shown. The window covering includes a head rail 12 and a ballast element 14. Ballast element 14 may be a bottom rail and is preferably of sufficient weight to keep the window covering properly extended in the window space. The window covering 10 also has at least one light blocking element 16. These light blocking elements 16 are shown in FIGS. 2A and 2B as cellular structures, but they may also take the form of slats, sheets, or other suitable structures.

At least one suspension cord 18 connects the head rail 12 with the ballast element 14. Preferably, at least two suspension cords are used to maintain symmetrical balance across the width of the window covering 10. The suspension cords 18 are associated to the light blocking elements 16. It should be understood that the light blocking elements 16 may be directly connected to the suspension cords 18, but suspension cords 18 may also be indirectly connected to the light blocking element 16 through intermediate structures such as cord loops or pass through light blocking element 16. Light blocking elements 16 are also preferably connected to the ballast element 14 and the suspension mechanism 30 by direct or indirect connections via suspension cords 18.

While the following discussion is in terms of bottom-up style window coverings, it should also be understood that the present invention is suitable for use in top-down style window coverings. In a top-down style window covering, the suspension cords would be associated with the light blocking element and may or may not be connected to the ballast element.

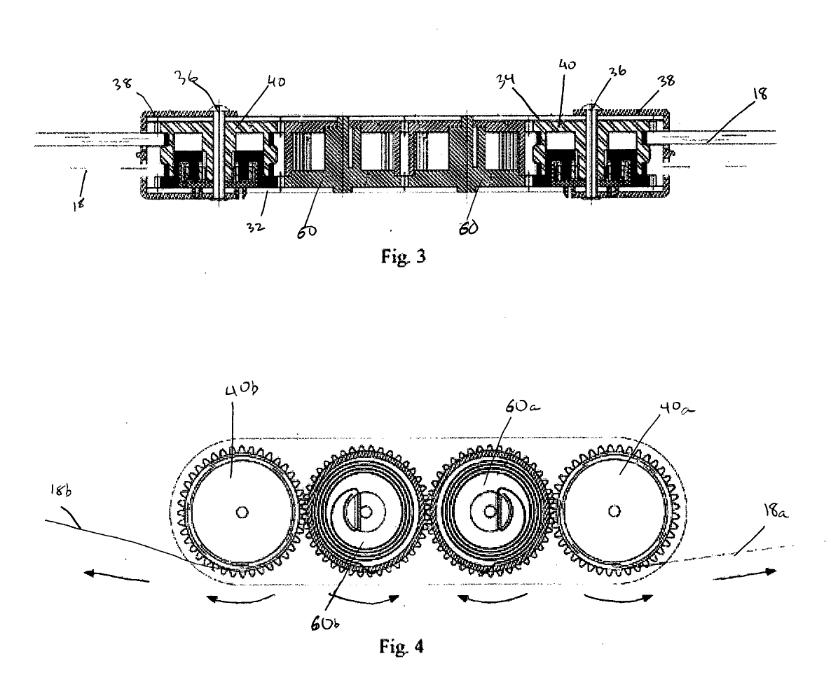

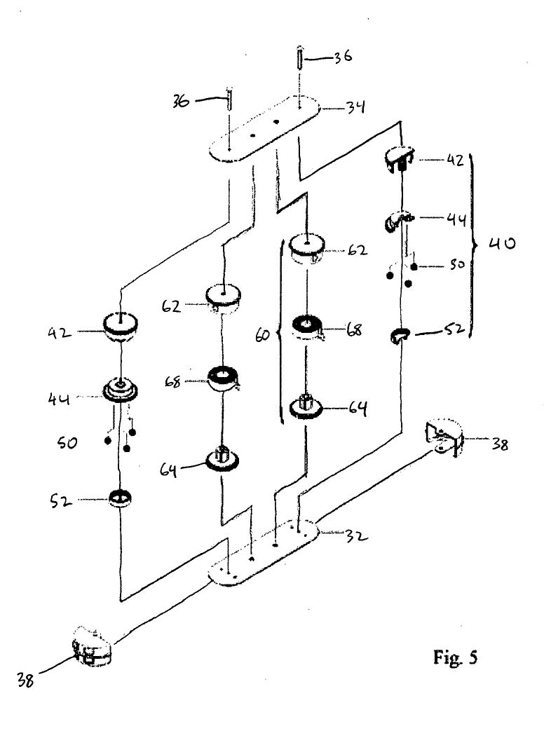

FIGS. 3 and 4 show a preferred embodiment of suspension mechanism 30. Suspension mechanism 30 can be mounted in the head rail 12 or the ballast element 14. The suspension mechanism 30 is connected to the ballast element 14 by suspension cords 18 or directly by virtue of being mounted in the ballast element 14. In the illustrated embodiment, the suspension mechanism 30 is mounted inside the head rail 12. The suspension mechanism 30 includes two subassemblies, a winding gear assembly 40 and a loading gear assembly 60. These assemblies are mounted onto a bottom plate 32 and may be further secured by a top plate 34, pins 36, and side housings 38. The winding gear assembly 40 and the loading gear assembly 60 are linked by a transmission system of gears described herein.

A suspension cord 18 is wound and unwound by the winding gear assembly 40. The winding gear assembly 40 is capable of being rotated in either direction depending on whether a suspension cord 18 is being wound or unwound, i.e. whether the window covering is being raised or lowered. In window coverings with two suspension cords 18a and 18b as shown in FIG. 4, the suspension mechanism 30 has two winding gear assemblies 40a and 40b and two loading gear assemblies 60a and 60b. Suspension cord 18a cooperates with winding gear assembly 40a and loading gear assembly 60a, while cord 18b cooperates with winding gear assembly 40b and loading gear assembly 60b. Winding gear assembly 40a and 40b are identical, as are loading gear assemblies 60a and 60b.

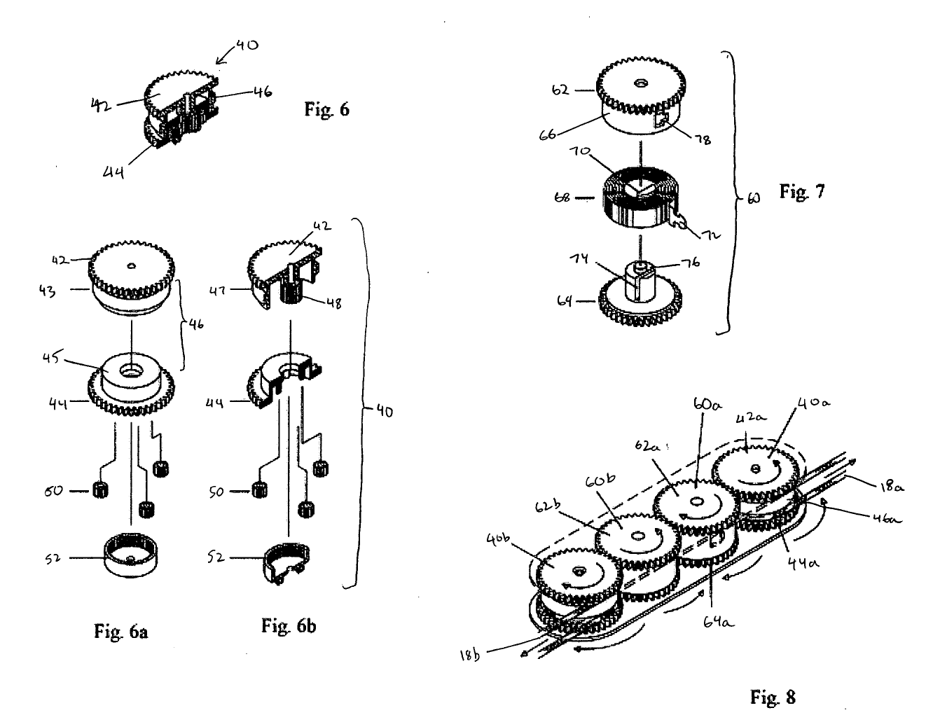

As can be more clearly seen in FIGS. 5 and 6, the winding gear assembly 40 comprises a first winding gear 42 and a second winding gear 44. As will be further explained, the second winding gear 44 serves as a differential gear relative to first winding gear 42. The first winding gear 42 and the second winding gear 44 are spaced by a rotary winding drum 46. As shown in FIGS. 6A and 6B, rotary winding drum 46 is composed of two nesting parts 43 and 45 that are joined to the first winding gear 42 and the second winding gear 44 respectively. It should be understood that the rotary winding drum 46 may also be integrally connected to only the first winding gear 42 or the second winding gear 44. Furthermore, the rotary winding drum 46 may alternatively take the configuration of a housing integral to a winding gear and a groove for receiving the lip of the housing in the opposite winding gear. The rotary winding drum 46 has a surface 47 suitable for winding and unwinding a suspension cord 18. To minimize bulk and conserve space, first winding gear 42, second winding gear 44, and the rotary winding drum 46 are in coaxial alignment with each other.

In this particular embodiment, the first winding gear 42 and the second winding gear 44 are in alignment with each other and are configured to rotate at different rotational displacements. Specifically, the second winding gear 44 rotates at a slower rotational displacement than the first winding gear 42. Differential rotation displacement between the first winding gear 42 and the second winding gear 44 can be accomplished in a number of ways. In a preferred embodiment, a pinion gear 48 is integrally connected to the axis of the first winding gear 42. Pinion gear 48 is in engagement with a set of planetary gears 50. The planetary gears 50 engage with a ring gear 52, which rotates with the second winding gear 44. The ring gear 52 may also be integrally joined with the second winding gear 44.

Rotation of the first winding gear 42 drives the rotation of the second winding gear 44 through the pinion gear 48 and planetary gears 50. Pinion gear 48 and planetary gears 50 are chosen so that the rotation of the first winding gear 42 drives the rotation of second winding gear 44 in the same direction as the first winding gear 42 but at a slower rate. Pinion gear 48 and planetary gears 50 thus serve to create a differential rotational displacement between first winding gear 42 and second winding gear 44. Since the first winding gear 42 and the rotary winding drum surface 47 are integrally connected in the configuration shown in FIGS. 6A and 6B, both the first winding gear 42 and the rotary winding drum surface 47 rotate together at the same rotational displacement relative to each other and at a differential rotational displacement relative to the second winding gear 44.

It should be noted that the differential rotational displacement ratio between the first winding gear 42a and the second winding gear 44a can be controlled by selection of the pinion gear 48 and planetary gears 50. The differential rotational displacement ratio in turns translates to a reduced movement range of the coiled spring 68 that is needed in relation to the movement of the suspension cord. Thus for a given spring length, the expansion range of the window covering is increased by a factor related to the differential gear ratio. This use of differential gear ratios reduces the needed extension range of the spring for a given expansion range of a window covering. This spring extension range reduction is preferable since it ensures that the spring remains in its linear response range during the entire range of the window covering's motion. This in turn prevents undesired variations in the resisting force to the constant downward force caused by the gravitational weight of the window covering that may otherwise be caused by excessive spring extension.

Referring to FIG. 7, the loading gear assembly 60 comprises a first loading gear 62 and a second loading gear 64. Disposed between the first loading gear 62 and the second loading gear 64 is a rotary loading drum 66, which is rotatably mounted on an axle 76. Rotary loading drum 66 is similar in size and radius as the rotary winding drum 46. As shown, the rotary loading drum 66 is integrally connected to the first loading gear 62. The axle 76 is rotatable relative to the rotary loading drum 66 and is connected to the second loading gear 64. Like the winding gear assembly 40, the first loading gear 62, the second loading gear 64, and the rotary loading drum 66 are coaxially assembled with one another.

A spring or other resilient means, such as coiled spring 68 or other constant force spring, is mounted inside the rotary loading drum 66. As seen in FIG. 7, spring 68 has an inner end 70 and an outer end 72. The inner end 70 of the spring 68 is fixedly secured to a slot 74 on axle 76. At the outer end 72 of spring 68 is a tab that is fixedly secured to a slot 78 disposed on the rotary loading drum 66. The first loading gear 62 and the second loading gear 64 rotate are free to rotate at different rotational displacements relative to each other.

FIG. 8 shows the relationship between the winding gear assembly 40a and the loading gear assembly 60a in the suspension mechanism 30. The first winding gear 42a is in engagement with the first loading gear 62a. Similarly, the second winding gear 44a is in engagement with the second loading gear 64a. Since the second winding gear 44a rotates at a slower rotational displacement than first winding gear 42a, the second loading gear 64a also rotates at a slower rotational displacement relative to second loading gear 64a. The differential rotation displacements between the first loading gear 62 and the second loading gear 64 result in a relative displacement between inner end 70 and outer end 72 of spring 68. This results in a storing or releasing of tension on the spring through extension and contraction. Those of ordinary skill in the art will understand that spring 68 may be secured or connected to the first loading gear 62 and the second loading gear 64 in other ways. Spring 68 may be chosen so that the spring is in its linear response range over the entire range of movement of the window covering.

The operation of the suspension mechanism 30 will now be described. When the user pulls down on the bottom rail or ballast portion of the window covering, suspension cord 18a is unwound from the rotary winding drum 46a and away from suspension mechanism 30. The force exerted on suspension cord 18a in a direction away from the suspension mechanism 30 exceeds the force exerted by the spring 68 in the loading gear assembly 60. This force imbalance unwinds the cord 18a from rotary winding drum 46a, inducing a counterclockwise rotation of rotary winding drum 46a in winding gear assembly 40a. Since rotary winding drum 46a is fixedly connected to first winding gear 42a, the first winding gear 42a also rotates in a counterclockwise direction.

Owing to pinion gear 48 and the planetary gears 50 (as previously shown in FIGS. 6a and 6b) within the winding gear assembly 40a, the second winding gear 44a also rotates counterclockwise. Since the pinion gear 48 and the planetary gears 50 are selected to create a differential gear ratio between first winding gear 42a and second winding gear 44a, the second winding gear 44a rotates at a lower rotational displacement than first winding gear 42a. The counterclockwise rotation of first winding gear 42a and second winding gear 44a also drives the clockwise rotation of first loading gear 62a and second loading gear 64a respectively. As explained previously, the first loading gear 62a and second loading gear 64a are capable of different rotation displacements relative to each other. Since the first winding gear 42a rotates at a higher rotational displacement than second winding gear 44a, that movement is transferred to the loading gear assembly 60a, resulting in the first loading gear 62a having a higher rotational displacement than the second loading gear 64a.

It will be recalled from FIG. 7 that the inner end 70 of spring 78 is mounted on axle 76, which rotates together with second loading gear 64a. Similarly the outer end 72 of spring 68 is mounted on the rotary loading drum 66a, which rotates together with first loading gear 62a. While both the axle 76 and the rotary loading drum 66a rotate in the same direction, the rotary loading drum 66a rotates at a higher rotational displacement relative to the rotation displacement of axle 76. Consequently, the outer end 72 of spring 68 thus has a higher rotational displacement than the inner end 70. Owing to the rotation of the axle 76, rotation of the spring 68 can be defined by the relative rotational displacement between the inner end 70 and the outer end of the 72 is less than the overall rotational displacement of outer end 72.

This differential in rotational displacement causes coil spring 68 to be extended, but at a lesser rotational displacement than the rotation of the rotary winding drum 46a and rotary loading drum 66a. In other words, the rotary winding drum 46a rotates faster than the relative rotational displacement between the inner end 70 and the outer end 72 of spring 68. As a result, the coiled spring contracts at an effective rotational displacement slower than the rotational displacement of the rotary winding drum 46a. In a preferred embodiment, the differential ratio between the rotation of the rotary winding drum 46a and the effective rotational displacement of the spring is between about 1.5 to 1 and 5 to 1. In an exemplary embodiment, the differential ratio is 3 to 1. Put another way, for one contracting revolution of the coil spring 68, the rotary winding drum 46a completes three revolutions. This differential permits the rotary winding drum 46a to deploy and retract greater lengths of the suspension cord relative to the corresponding length and contraction of spring 68.

The second winding gear assembly 40b and the second loading gear assembly 60b operate in the same manner in response to movement of suspension cord 18b, with the rotational directions reversed. The first loading gear assembly 60a and the second loading gear assembly 60b may be in engagement with each other as shown in FIG. 8. By engaging the two loading gear assemblies 60a and 60b, additional tension is brought to bear on both suspension cords 18a and 18b. Furthermore, the engagement of the two loading gear assemblies synchronizes their rotation, ensuring symmetrical deployment and retraction of suspension cords 18a and 18b.

The operation of the suspension mechanism 30 is reversible. When a user lifts the ballast portion of the window covering, some slack in suspension cord 18a is created. Without the downward force on suspension cord 18a resisting the contraction of spring 68, spring 68 contracts and induces the rotation of the loading gear assembly 60a and the winding gear assembly 40a. This in turn causes rotation of rotary winding drum 46a to take up the slack in suspension cord 18a until the cord is taut.

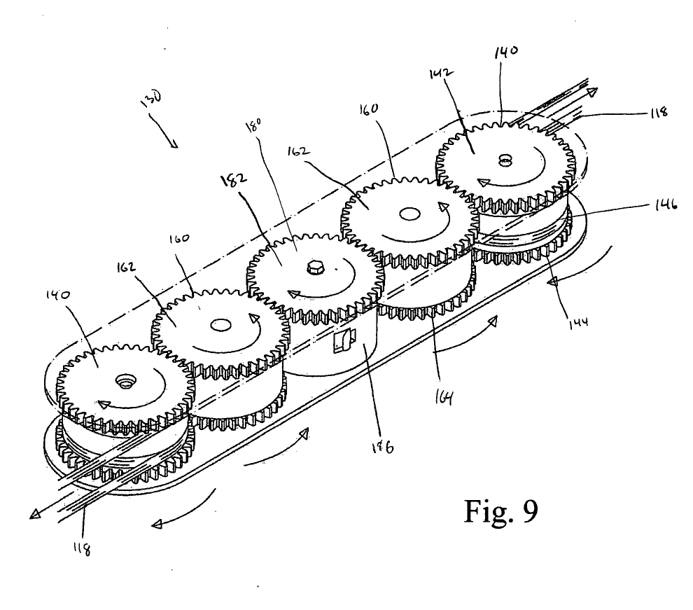

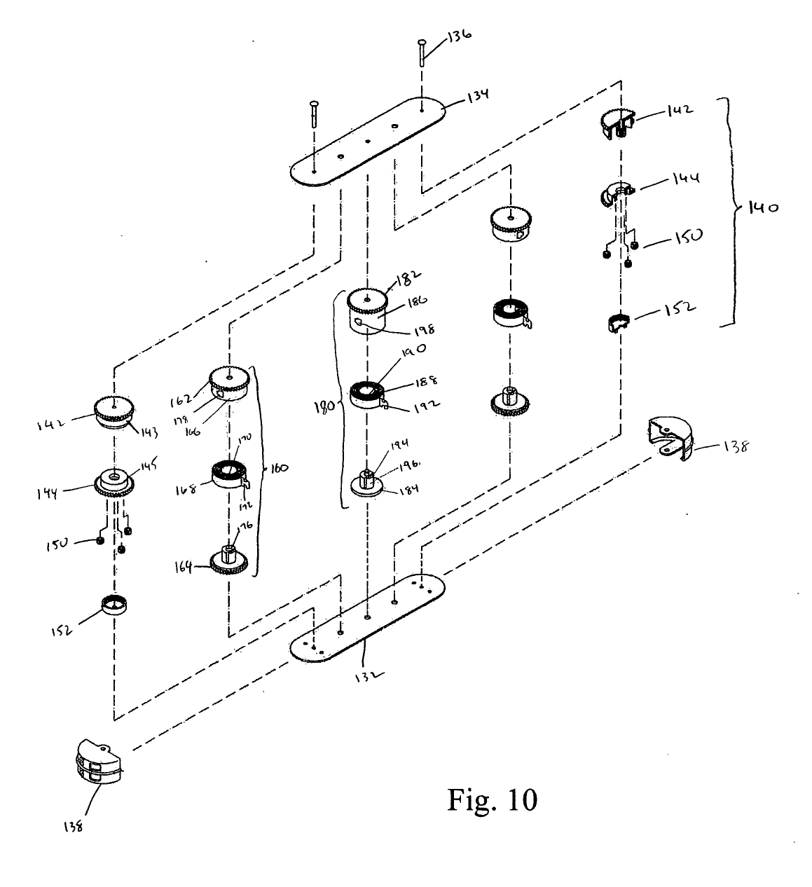

FIGS. 9 and 10 show an alternate preferred embodiment of the suspension mechanism of the present invention. In this embodiment, the suspension mechanism 130 includes two winding gear assemblies 140 and two loading gear assemblies 160 held together between bottom plate 132 and top plate 134 by pins 136 and side housings 138. Similar to the previous embodiment, winding gear assembly 140 comprises a first winding gear 142 and a second winding gear 144 spaced by a rotary winding drum 146 for winding and unwinding a suspension cord 118. Rotary winding drum 146 is composed of two nesting parts 143 and 145 that are joined to the first winding gear 142 and the second winding gear 144 respectively. Similar to the embodiment of FIG. 5, differential rotational displacements between the first winding gear 142 and the second winding gear 144 is achieved through the use of planetary gears 150 and a ring gear 152.

The loading gear assembly 160 comprises a first loading gear 162 and a second loading gear 164 with a rotary loading drum 166. Rotary loading drum 166 is integrally connected to the first loading gear 162 and is rotatably mounted relative to axle 176 connected to the second loading gear 164. A spring 168 is mounted inside the rotary loading drum 168. The inner end of 170 of spring 168 is fixedly secured to the axle 176, while the outer end 172 is fixedly secured to a slot 178 disposed on the rotary loading drum 166. The operation of winding gear assembly 140 and loading gear assembly 160 is substantially similar to that previously described in relation to the embodiment of FIG. 8. In other words, the differential rotational displacements between the first winding gear 142 and the second winding gear 144 translates to a relative rotational displacement between the inner end 170 and the outer end 172 of spring 168 that is less than the rotational displacement of rotary winding drum 146. Thus for every revolution of extension by spring 168, revolution of rotary winding drum 146 completes several revolutions, thus extending longer lengths of cord 118 per length of spring extension.

As shown in FIG. 9, disposed between the two loading gear assemblies 160 is a central gear assembly 180. Central gear assembly 180 has a central gear 182 attached to a central rotary drum 186. Central gear 182 engages loading gears 162 of the adjacent loading assemblies 160. A central axle 196 is mounted on central base 184, which itself is non-rotatably mounted to the bottom plate 132. Disposed within the housing of the central rotary drum 186 is a central spring 188 with an inner end 190 and an outer end 192. The inner end 190 of central spring 188 is fixedly secured to central axle 196 by slot 194. The outer end 192 of central spring 188 is fixedly secured to the central rotary drum 186 by a slot 198 disposed on the central rotary drum 186.

Since central base 184 and central axle 196 does not rotate, the inner end of central spring 188 is rotatably fixed. Rotation of the central gear 182 tensions central spring 188 by only movement of the outer end 192. Since the central spring 188 is extended and contracted only by movement of the outer end 192 rather than both the outer 192 and the inner end 190 as in the loading gear assemblies 160, the central spring 188 is capable of providing tighter tension as the central gear assembly 180 rotates. This is particularly useful to strengthen the tension exerted through suspension cords 118 in larger sized window shades.

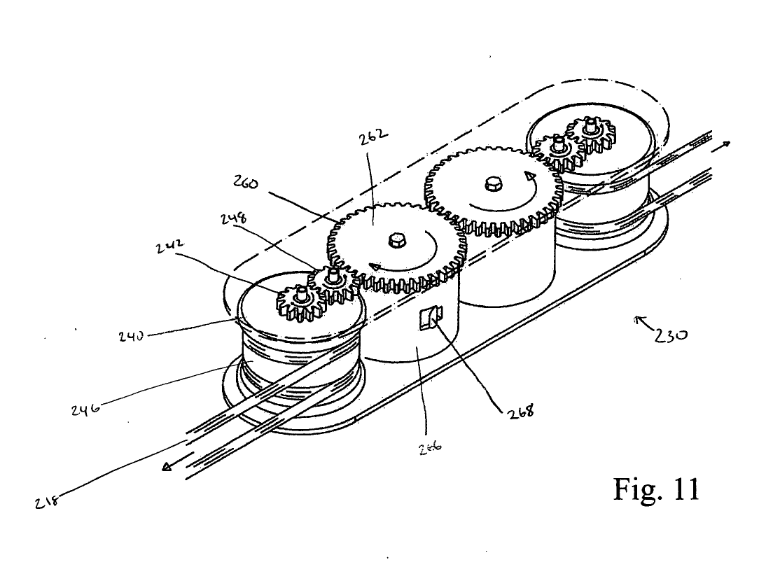

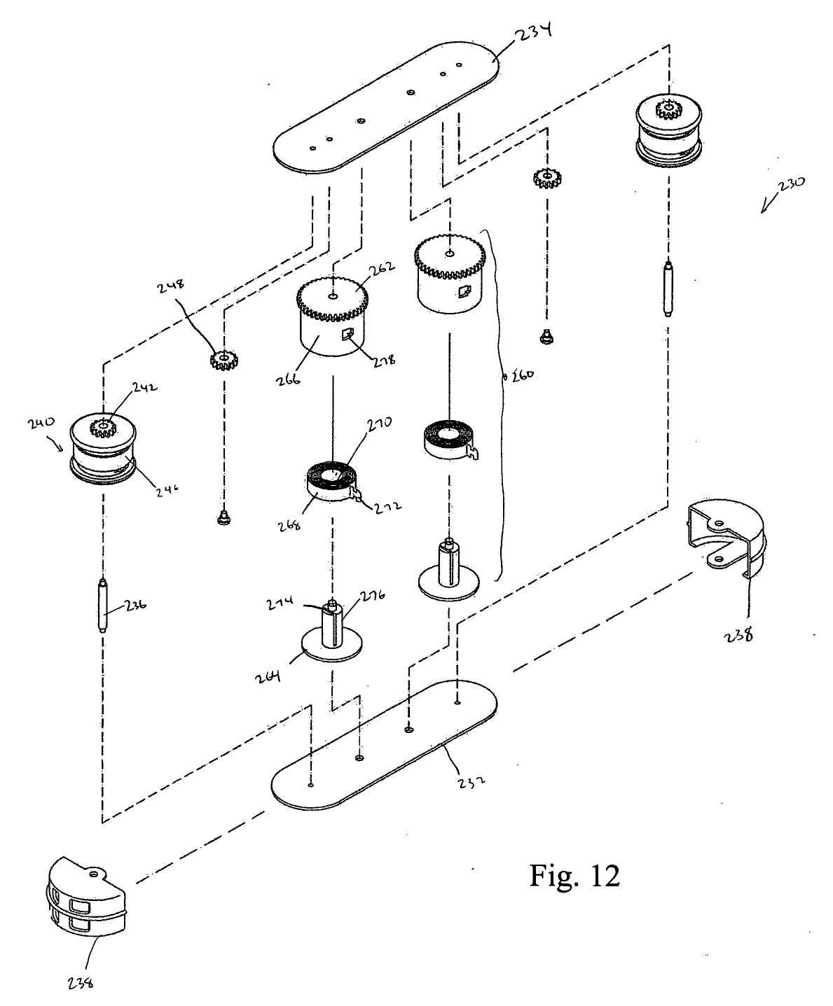

FIGS. 11 and 12 show yet another alternate preferred embodiment of the present invention. In this embodiment, suspension mechanism 230 includes winding gear assembly 240 and loading gear assembly 260. Winding gear assembly 240 is composed of a winding gear 242 connected to a winding drum rotary winding drum 246. The winding gear assembly 240 is mounted by axle pin 236 between bottom plate 232 and top plate 234. Loading gear assembly 260 is composed of a rotary loading drum 266 integrally connected to a loading gear 262. Mounted inside the rotary loading drum 266 is a constant force spring 268 with an inner end 270 and an outer end 272. The inner end 270 of spring 268 is secured to a slot 274 on axle 276 disposed rotary loading drum base 264. The outer end 272 of spring 268 is fixedly secured to a slot 278 disposed on the rotary loading drum 266.

A differential rotational displacement between the rotary winding drum 246 and the spring 268 is obtained by changing relative number of teeth between winding gear 242 and loading gear 262. Thus in rotation, winding gear 242 rotates at a greater rate than loading gear 262. A pinion gear 248 may be disposed in engagement between the winding gear 242 and loading gear 262. Rotation of the winding gear 242 in one direction thus causes rotation of the loading gear in the same direction through the action of pinion gear 248.

In the operation of this embodiment, the winding gear assembly 240 rotates as suspension cord 218 is pulled away from the suspension mechanism 230. This causes the winding gear 242 to rotate with the rotary winding drum 246. The rotation of winding gear 242 induces the rotation of pinion gear 248 and loading gear 262. Rotary loading drum base 264 is stationary, fixing the inner end 270 of the spring 268 from rotation. Rotation of the loading gear 262 and rotary loading drum 266 thus tensions the spring 268 by rotating the outer end 272 of spring 268 relative to the rotatably fixed inner end 270.

Owing to the difference in radii between winding gear 242 and loading gear 262, winding gear 242 rotates for several revolutions for each revolution of the loading gear 262. For example, where the gear ratio between the winding gear 242 and the loading gear 262 is 3 to 1, rotary winding drum 246 completes three revolutions for every revolution of the rotary loading drum 266. In other words, for every revolution of the spring 268 in the rotary loading drum 266, a length of suspension cord 218 equal to three circumferences of rotary winding drum 246 is deployed. This permits the suspension cord to be deployed over a greater range with a smaller extension of the spring.

The foregoing description and the drawings are illustrative of the present invention and are not to be taken as limiting. Still other variants and rearrangements of parts within the spirit and scope of the present invention are possible and will be readily apparent to those skilled in the art.

What is claimed is:

1. A window covering comprising:
a ballast element;
an adjustable light blocking element connected to the ballast element;
at least one suspension cord associated with the light blocking element; and
a suspension mechanism connected to the suspension cord to adjust the light blocking element, the suspension mechanism having:
a first rotary drum adapted to wind and unwind the suspension cord;
a spring having a first end, and a second end mounted on an axle, the first end being rotatable with respect to the second end; and
a transmission system operatively connecting the first rotary drum and at least one end of the spring to transmit a rotating movement at a differential rotation rate between the first rotary drum and the one end of the spring such that the first rotary drum rotates at a faster rate than an effective rotational displacement of the spring.

2. The window covering of claim 1, wherein the spring is a constant-force spring.

3. The window covering of claim 1, wherein the window covering further comprises a second rotary drum with the one end being the first end of the spring connected to the second rotary drum.

4. The window covering of claim 3, wherein the transmission system links at least the first rotary drum and the first end of the spring.

5. The window covering of claim 4, wherein the transmission system also links the first rotary drum and the axle.

6. The window covering of claim 5, wherein the rotation of the first rotary drum drives the rotation of the second rotary drum and the rotation of the axle such that rotational displacement of the first end of the spring connected to the second rotary drum is greater than the rotational displacement of the second end of the spring mounted on the axle.

7. The window covering of claim 1, wherein the ratio between the rotational displacement of the first rotary drum and the effective rotational displacement of the spring ranges from about 1.5 to 1 to about 5 to 1.

8. The window covering of claim 4, wherein the axle is fixed from rotation.

9. The window covering of claim 8, wherein the transmission system comprises a winding gear connected to the first rotary drum and a loading gear connected to the second rotary drum, the winding gear and the loading gear configured to rotate at different rotational displacements to set a differential rotation rate between the first and second rotary drums.

10. The window covering of claim 9, wherein the winding gear is connected to the loading gear by a pinion gear.

11. The window covering of claim 8, wherein the ratio in the differential rotation rate between the first rotary drum and the second rotary drum is greater than about 1.5 to 1 and less than about 5 to 1.

12. A window covering comprising:
a ballast element;
at least one light blocking element connected to the ballast element;
a suspension cord associated with the light blocking element;
a suspension mechanism engagingly connected to the suspension cord, the suspension mechanism comprising:
a spring having a first end and a second end;
a rotary winding drum for winding and unwinding the suspension cord;
a rotary loading drum connected to the first end of the spring and driven in rotation by a rotation of the rotary winding drum; and
a rotary axle connected to the second end of the spring and rotating at a different rate relative to the rotary loading drum such that the rotary winding drum has a rotation rate greater than an effective rotational displacement of the spring.

13. The window covering of claim 12, wherein the spring is a constant-force spring.

14. The window covering of claim 12, wherein the suspension mechanism mounted in a head rail of the window covering.

15. The window covering of claim 12, wherein the ratio between the rotational displacement of the rotary winding drum and the effective rotational displacement of the spring ranges from about 1.5 to 1 to about 5 to 1.

16. The window covering of claim 12, wherein the rotary winding drum is further connected to a second winding gear and the axle is further connected to a second loading gear;
the first winding gear and the second winding gear are operatively connected by a planetary gear in differential gearing engagement.
the first winding gear being operatively connected with the first loading gear; and
the second winding gear being operatively connected with the second loading gear.

17. A window covering comprising:
a ballast element;
an adjustable light blocking element connected to the ballast element;
at least two suspension cords associated with the light blocking element; and
a suspension mechanism connected to the suspension cords to adjust the light blocking element, the suspension mechanism having:
two rotary winding drums each respectively adapted to wind and unwind a respective suspension cord;
two rotary loading drums adapted for each respective suspension cord, each rotary loading drum further having an axle and a constant force spring having a first end and a second end, the first end of the spring being connected to the rotary loading drum and the second end of the spring being mounted on the axle;
a transmission system operatively connecting the rotary winding drum and at least one end of the spring to transmit a rotating movement at a differential rate between the rotary winding drum and the one end of the spring; and
each rotary loading drum is in operative engagement with each other and rotates at about the same rotational displacement rate.

18. The window covering of claim 17, wherein each rotary loading drum is connected by operative engagement to a central rotary drum disposed therebetween in operative engagement with each rotary loading drum, the central rotary drum further having a central axle and a central spring having a first end connected to the central rotary drum and a second end mounted on the central axle.

19. The window covering of claim 17, wherein the central axle is fixed from rotation.

20. A suspension mechanism for use in a window covering with a suspension cord, the suspension mechanism comprising:
a first rotary drum adapted to wind and unwind the suspension cord;
a spring having a first end, and a second end mounted on an axle, the first end being rotatable with respect to the second end; and
a transmission system operatively connecting the first rotary drum and at least one end of the spring to transmit a rotating movement at a differential rate between the first rotary drum and the one end of the spring such that the first rotary drum rotates at a faster rate than an effective rotational displacement of the spring.

21. The suspension mechanism of claim 20, wherein the spring is a constant-force spring.

22. The suspension mechanism of claim 20, wherein the suspension mechanism further comprises a second rotary drum with the one end being the first end of the spring connected to the second rotary drum.

23. The suspension mechanism of claim 22, wherein the transmission system links at least the first rotary drum and the first end of the spring.

24. The suspension mechanism of claim 23, wherein the transmission system also links the first rotary drum and the axle.

25. The suspension mechanism of claim 24, wherein the rotation of the first rotary drum drives the rotation of the second rotary drum and the rotation of the axle such that rotational displacement of the first end of the spring connected to the second rotary drum is greater than the rotational displacement of the second end of the spring mounted on the axle.

26. The suspension mechanism of claim 20, wherein the ratio between the rotational displacement of the first rotary drum and the effective rotational displacement of the spring ranges from about 1.5 to 1 to about 5 to 1.

27. The suspension mechanism of claim 23, wherein the axle is fixed from rotation.

28. The suspension mechanism of claim 27, wherein the transmission system comprises a winding gear connected to the first rotary drum and a loading gear connected to the second rotary drum, the winding gear and the loading gear configured to rotate at different rotational displacements to set a differential rotation rate between the first and second rotary drums.

29. The suspension mechanism of claim 28, wherein the winding gear is connected to the loading gear by a pinion gear.

30. The suspension mechanism of claim 27, wherein the ratio in the differential rotation rate between the first rotary drum and the second rotary drum is greater than about 1.5 to 1 and less than about 5 to 1.
